(19) United States
(12) Patent Application Publication
(10) Pub. No.: US 2004/0124374 A1
(43) Pub. Date: Jul. 1, 2004

(54) Amorphous composition for high level radiation and environmental protection

(76) Inventor: Adrian Joseph, Laguna Niguel, CA (US)

Correspondence Address: REED SMITH CROSBY HEAFEY LLP, 1901 AVENUE OF THE STARS, SUITE 700, LOS ANGELES, CA, 90067, US

(21) Appl. No.: 10/346,680

(22) Filed: Jan. 16, 2003

Related U.S. Application Data
(63) Continuation-in-part of application No. 09/878,005, filed on Jun. 8, 2001, now Pat. No. 6,608,319.

(51) Int. Cl. G21F 5/00

(52) U.S. Cl. 250/507.1

(57) ABSTRACT

An improved nuclear shielding material based on a resistant organic matrix that is flexible or resilient after room temperature polymerization, and sufficiently fluid before polymerization so as to effectively fill voids in radiation containment structures. The material can be formulated to undergo pyrolysis and transform into a strong ceramic material. Along with the organic matrix the material contains a primary radiation shielding component such as tungsten carbide powder. Additional optional components include: a neutron absorbing/gamma blocking compound such as boron carbide powder, a heat conducting material such as diamond powder, a high temperature resistant compound such as silicon dioxide powder, a second neutron blocking compound which also imparts electrical conductivity, namely barium sulfate powder, and a hydrogen gas surpassing component which readily absorbs hydrogen such as sponge palladium. Refractory materials and rare earth oxides can be included to favor effective ceramic transition.

The present application is a continuation-in-part of U.S. patent application Ser. No. 09/878,005 filed Jun. 8, 2001.

### BACKGROUND OF THE INVENTION

1. Area of the Art

The present invention concerns the field of materials resistant to environmental extremes and in particular resistant to high levels of nuclear radiation

2. Description of the Prior Art

Nuclear energy and radioactive materials have posed seemingly insurmountable problems. There has been great public concern surrounding safety issues related to nuclear power plants, their design and operation. It appears that safe reactors are within the grasp of human engineering. The real problem posed may well be an environmental one caused by recycling and disposal of the spent nuclear fuels. Whether the spent fuels are reprocessed to yield additional fissionable material (the most efficient alternative from the view of long term energy needs) or whether the spent fuel is simply disposed of directly, there is a considerable volume of highly radioactive substances that must be isolated from the environment for long periods of time. The presently planned approach is the internment of the radioactive material in deep geologic formations where they can decay to a harmless level. Ideally these “buried” wastes will remain environmentally isolated with no monitoring or human supervision. Unfortunately, one does not simply dump the wastes in a hole. These materials are constantly generating heat, and the emitted radiation alters and weakens most substances. This makes it difficult to even contain the radioactive materials, as containers weakened by the intense radiation are prone to breakage and leaking. Furthermore, potentially explosive gases, primarily hydrogen, are generated by the interaction of radiation with many shielding materials. These problems impact both wastes and nuclear power plants. The safest possible design is to little avail if the structural elements of the power plant or the storage vessel deteriorate and/or experience hydrogen gas explosions.

In terms of waste the best present approach is to reduce the wastes to eliminate flammable solvents. The reduced wastes are then vitrified or otherwise converted into a stable form to prevent environmental migration. Generally, the reduced wastes (including spent fuel rods) are placed into a strong and resistant container for shipping and disposal. Ideally, such a container would show significant radiation shielding properties to facilitate transport and handling. In terms of nuclear power plants, conventional shielding materials such as concrete-based compositions are often employed. Unfortunately many conventional materials will eventually show significant radiation induced degradation. The hope is to replace such materials or decommission the power plant before there is excess deterioration. Nevertheless, there remains the important task of producing special materials that display unusual resistance to radiation, heat and chemical conditions that generally accompany nuclear plants and radioactive wastes. Ideally, such materials have radiation shielding properties and can be used to shield and incase otherwise reduced wastes as well as decommissioned or damaged nuclear facilities.

The simplest and crudest shielding material is probably concrete. Because of the mineral inclusions in simple portland cement based materials or similar materials to which additional shielding materials (e.g. heavy metal particles) have been added, these substances can provide significant shielding from nuclear radiation. However, simple concrete may not long survive under the severe chemical conditions produced in some nuclear facilities. In many applications the inherent brittleness of the concrete is also a problem. When jarred or dropped, concrete materials may develop cracks or leaks. Concrete tanks of liquid nuclear wastes have useful lifetimes of less than fifty years. Concrete is more resistant to reduced vitrified wastes but is still far from ideal.

There have also been a number of experiments with novel shielding-containment materials that would be easier to apply and have superior shielding and/or physical properties. The present inventor has disclosed such materials in U.S. Pat. No. 6,232,383. Although the material disclosed therein is a great advance over the prior art, it is not optimal in all aspects. The material shows tremendous tensile strength but is not ideal for applications where a certain amount of flexibility or resiliency is desirable. Also, the materials disclosed therein are designed to “cure”—that is to develop full strength—under conditions of elevated temperature. Often it is not feasible to sufficiently heat shielding materials to effect adequate curing. Further, the disclosed formulae may not always show optimal resistance to radiation induced production of hydrogen (radiolysis).

### SUMMARY OF THE INVENTION

The present invention is an improved nuclear shielding material that is initially a fluid so as to effectively fill voids in radiation containment structures. The material cures rapidly at room temperatures (that is, temperatures above about 5° C.) to a non-fluid condition. The material is based on an amorphous organic matrix and is resistant to heat and radiation. Depending on the precise matrix, the cured material ranges from flexible to resiliently rigid. The material can show significant ability to absorb hydrogen gas depending on its composition. Under very high temperatures the material is designed to undergo pyrolysis and transform into a strong ceramic material that retains the favorable radiation and hydrogen resistance of the original material.

As such the composition consists of uniform mixture of a plurality of component materials selected from seven different component groups. The first component is a polymeric elastomer matrix such as a two part self-polymerizing system like RTF silicone rubber or an epoxy resin and constitutes about 10%-30% by weight of the final composition. The second component is a material which acts as a gamma radiation shield, for example, tungsten carbide powder; the gamma shielding material makes up about 25%-75% by weight of the final composition. The third component is a combination neutron absorbing/gamma blocking material such as boron carbide powder and may constitute about 5%-10% by weight of the final composition. The fourth component is a heat conducting material such as diamond powder and may be up to about 5% by weight of the final composition. The fifth component is a high temperature resistant compound such as silicon dioxide powder and may make up to about 5% by weight of the final composition. The sixth component is an additional neutron absorbing compound which also imparts electrical conductivity, namely barium sulfate powder which may comprise up to about 2% by weight of the final composition. Lastly, the seventh component is a hydrogen gas surpassing component which readily absorbs hydrogen—materials such as sponge palladium or other metals or intermetallic compounds—and when present constitute about 2-8% of the final composition.

The organic elastomer (first component) is preferably a two-part catalyst system. For example, all of the other components can be uniformly mixed together and then uniformly mixed into Part A (the resin) of the RTF or other matrix material. Finally, Part B (the catalyst) is blended into the mixture which is then injected into its final location where it foams (in the case of RTF) polymerizes and hardens. Alternatively, other components can be uniformly blended into a mixture. Then part A and part B of the matrix can be uniformly blended and that mixture rapidly blended with the other component mixture and the resulting mixture injected into place before polymerization takes place.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide an improved nuclear shielding material that resists damage caused by radiation induced hydrogen production.

The present invention is an improved nuclear shielding material that is initially somewhat fluid so as effectively to fill voids in radiation containment structures. The material is based on an amorphous organic matrix and is resistant to heat and radiation. Additions of shielding materials and optionally hydrogen absorbing and/or conductivity enhancement materials are made to tailor the material to a particular application. Under very high temperatures the material is designed to undergo pyrolysis and transform into a strong ceramic material that retains the favorable radiation and hydrogen resistance of the original material. As such the composition consists of uniform mixture of up to seven different component groups. Abbreviated descriptions are given here with more detail below:

1) An organic polymeric elastomer matrix (ideally a two part self-polymerizing system)(about 10%-30% by weight of the final composition);

2) A gamma radiation shielding component (for example, tungsten carbide powder, 99% pure, 50-200 μm average grain size preferred)(about 25%-75% by weight of the final composition);

3) A neutron absorbing/gamma blocking component (for example, boron carbide powder, 50-200 μm average grain size preferred)(about 5%-10% by weight of the final composition when present);

4) A heat conducting component (diamond powder, 50-200 μm average grain size preferred)(about 0%-5% by weight of the final composition);

5) A high temperature resistant component (silicon dioxide powder, 50-200 μm average grain size preferred)(when present up to about 5% by weight of the final composition);

6) A neutron absorbing/electrical conductivity-enhancing component (barium sulfate powder)(when present up to about 5% by weight of the final composition); and

7) A hydrogen gas absorbing component (sponge palladium or other metals or intermetallic compounds that readily absorb hydrogen)(about 2%-8% by weight of the final composition when present).

The first component (component group one) is a flexible or resilient organic matrix in which all of the other components are evenly suspended. The matrix material is preferably a flexible silicon rubber material (such as RTF 762 manufactured by the Silicon Division of General Electric Corporation) or an epoxy resin system. The organic matrix is a two-part catalyst system so that all of the other component groups can be uniformly mixed together and then uniformly mixed into the first part of the organic matrix. For example with RTF (‘RTF’ stands for “room temperature foam”) two components—Part A and Part B—are mixed to form the final RTF material. To make the inventive composition, the shielding and other components are uniformly blended into one of the matrix components—for example into Part A. Then the second part of the matrix—Part B in this RTF example is blended into the mixture, which is then injected into its final location where it foams, polymerizes and hardens. Alternatively, the desired selection of components 2-7 can be uniformly blended into a mixture. Then part A and part B of the RTF (or other suitable organic matrix) can be uniformly blended and that mixture rapidly blended with the 2-7 component mixture with the resulting mixture being injected into place before foam formation and subsequent polymerization has substantially occurred.

The matrix provides the required flexibility/resiliency, shock resistance and tensile strength to the material. Depending on formulation the matrix can exist in a porous or non-porous state. Non-porous matrices can be formed with RTV (“room temperature vulcanization”) silicone rubber products or a variety of polyester and specialty aromatic epoxy resin systems. The advantage of the foam materials is somewhat lower weight and the ability to expand and fill voids upon injection into a structure. The goal is to eliminate all voids that are larger than about 5 mm because under intense radiation such voids can accumulate hydrogen gas and may pose a danger of explosion. Alternatively, use of a non-foam matrix (e.g., RTV or epoxy) can show increased strength and shielding ability, which may be advantageous under certain circumstance.

An important consideration in the choice of RTF or other systems for the matrix material is the existence of aromatic radicals in the polymer. Various studies have shown that aromatic materials show a much higher radiation resistance than do, for example, polysiloxanes and acrylic resins with mostly aliphatic radicals. A study on the radiation resistance of isoprene rubber demonstrated that the addition of polycyclic aromatic compounds greatly increased the rubber's resistance to radiation. Benzantracene, diphenyl and phenantrene were shown to be the most effective. With such additives rubber irradiated in a vacuum was able to withstand a dose of 400 Mrad without appreciable structural deterioration. It is believed that aromatic rings afford a route for intramolecular transfer and dissipation of excitation energy. This may significantly reduces the amount of hydrogen released on irradiation. That is, the aromatic carbon-carbon bonds involved in these polymers are resistant to radiation loads and environmental attacks. Polymers containing aromatic radicals, and especially benzantracene, diphenyl and phenantrene groups are especially preferred in the present invention.

Other organic matrix elastomers and polymers are also usable in the present invention including siloxanes, silanols, vinyl elastomers (such as polyvinyl chlorides), and fluorocarbon polymers and elastomers. Again, polymers containing aromatic radicals are preferred.

While the matrix provides basic strength and flexibility/resiliency, the other six components are selected to provide various types of radiation resistance and/or enhancement to the basic mechanical-physical properties of the matrix.

Component 2 provides significant shielding against gamma radiation. All formulations contain at least components 1 and 2. Gamma radiation shielding is important both because it limits the amount of dangerous gamma radiation exiting the shielded container (where it could be a biological hazard) and because the shielding limits the exposure of the organic matrix material to strong radiation. Such exposure results in the gradual deterioration of the matrix and in the radiolytic production of hydrogen, which may result in a fire or explosion hazards. In situations with particularly high radiation fluxes as in containers for spent nuclear fuel, Component 2 can advantageously be supplemented with one or more additional shielding compounds. Such shielding compounds are generally powders of chemically pure heavy metals such as copper, lead, tin, tungsten, antimony, indium, and bismuth. These choices are a matter of balancing the opposing factors of cost, weight, environmental toxicity and the requirements for shielding. While pure metal powders are useful, it is also advantageous to use salts as the shielding metals. Iodide salts of the metallic shielding materials can be especially advantageous because iodine itself is a good shielding material.

Tungsten carbide is preferred as a primary shielding material (although metallic tungsten powder can also be used) because it is physically compatible with the matrix (i.e., the matrix polymers bind to the carbide) and because it can form a ceramic component under pyrolytic conditions. To this end oxides of heavy metals such as cerium and zirconium with high melting points (and even lighter ceramic compounds such as magnesium and aluminum oxide) are advantageously included to potentially form a strong ceramic material. As is well understood in the art of refractory ceramics, it is important to avoid the inclusion of ceramic oxides that could form eutectic mixtures with low melting points. The addition of ceramic forming agents is optional and is based on the likelihood of the particular application resulting in sustained temperatures above about 900° C.

Component 3 has the primary task of absorbing neutrons. Because the organic matrix of the present invention is essentially transparent to neutrons, use of this invention without neutron absorbers could result in an increase in neutron flux as compared to other traditional shielding materials such as concrete. In some instances this could even result in a the danger of a chain reaction. The primary neutron absorber used is boron (but also see component 6). Boron is advantageously present as boron carbide because of the physical compatibility with the matrix. However, other forms of boron may also be used. For example, boron nitride may provide advantageous thermal conductivity and strength. In addition, more “exotic” neutron absorbers such as cadmium and gadolinium can be included to supplement the boron. It will be apparent to one of ordinary skill in the art that applications with no or a low neutron flux can advantageously use composition with no or a low amount of component 3, respectively.

Component 4, diamond powder, is an optional component that can be partially responsible for high temperature resistance of the final product. The various shielding metals of the other components show relatively high thermal conductivity and help conduct heat out of the shielding material, thereby maintaining its favorable flexibility and related properties. However, diamond powder shows extremely high thermal conductivity as well as strength and thermal resistance (in a non-oxidizing atmosphere). Therefore, diamond powder can advantageously be included to help maintain temperature of the matrix below temperatures that would result in pyrolysis. Because the various shielding metals also contribute to thermal conductivity, it is possible to omit the diamond powder especially where at least some of the gamma shielding material is present in a metallic state (e.g., copper powder).

Component 5, silicon dioxide, is an optional component responsible for thermal resistance and strength at high temperatures. Should pyrolysis occur the silicon dioxide can form part of the newly generated ceramic. If other ceramic-forming metal oxides are included or for lower temperature applications, this component can be omitted.

Component 6, barium sulfate, is a secondary shielding component that is effective both as a gamma radiation shield and a neutron absorber. In addition, it provides sufficient electrical conductivity to discharge free electrons released by interaction between the inventive composition and a strong radiation flux. These electrons can be involved in radiolytic breakdown and hydrogen production. Discharging or short-circuiting these currents can help avoid radiolytic breakdown and hydrogen formation. Since a primary purpose of component 3 is also neutron absorption, it is possible to omit component 6 particularly when metallic components are included as these components also enhance electrical conductivity and/or in conditions of a negligible neutron flux.

Finally, component 7 can be included to deal with hydrogen that forms despite the shielding materials and other additives used to minimize its formation. The “gas suppressants” that make up component 7 are metallic and intermetallic compounds that readily absorb and bind hydrogen at relatively low temperatures and low partial hydrogen pressures. These materials include sponge palladium produced, for example, through the thermal decomposition of organo-palladium compounds and various readily “hydrogenated” metals such as lithium, nickel, vanadium, calcium, scandium and titanium and compounds formed from these metals. Further, several of these are of sufficiently high atomic weight to also function as gamma shields. Of especial interest are intermetallic compounds such as the various lithium nickel (“lithiated”) compounds, lanthanum nickel compounds, samarium cobalt compounds, yttrium nickel compounds and yttrium cobalt compounds, all of which show significant ability to absorb hydrogen.

In some situations, high radiation flux dictates that the hydrogen absorber-gas suppressant will become relatively rapidly saturated with hydrogen. When this occurs, hydrogen will diffuse through the inventive composition because the matrix material is relatively permeable to hydrogen. The first thing that will occur is that any pores in the material (pores are prevalent in the foam version) will fill with hydrogen. This could result in an explosion hazard as atmospheric oxygen and hydrogen can mix in the pores. However, this danger is considerably minimized by the small pore size of the foam. Generally the pores are smaller than the average effective trace length of radicals active in the hydrogen oxidation reaction (which amounts to several centimeters at atmospheric pressure). Therefore, the probability of developing a self-sustaining oxidation circuit is negligible due to quenching on the walls of the pores. The most likely scenario is that hydrogen will gradually infiltrate the pores and displace other gases therein. Eventually, there will be a steady escape of hydrogen from the surface of the material. Therefore, depending on the rate of hydrogen evolution, it may be necessary to provide some sort of ventilation system to safely gather and dispose of the escaping hydrogen.

Finally, should thermal conductivity enhancers and other precautions fails to keep the composition at a temperature below 1,000° C. or so the composition can undergo a pyrolytic transition (generally at 1,100-1,200° C.) into an extremely strong ceramic. In the ceramic state the flexibility/resiliency characteristics of the composition are largely lost; however, the overall shielding properties of the material are not significantly altered. If radiation and related conditions make the ceramic transition at all likely, provision should be made to exhaust the various gases released by pyrolysis. Ventilation systems provided to deal with hydrogen efflux could also serve to remove pyrolytic gases.

There are a wide variety of applications of the present inventive composition. Depending on the precise conditions, differing mixtures of components are preferred. Table 1 shows a variety of application along with the physical form of the inventive shielding material and sketch of the dominant components used in the shielding material for that application.

TABLE 1

| Application | Formula | Application Method |
|---|---|---|
| Nuclear Power Station (Maintenance) | Bismuth metal + polyester | Pre-fabricated Plates |
| | epoxy | |
| N.P.S. on sight storage (Dry cask) | Bismuth metal + polyester | On Location Liquid |
| | epoxy | |
| M.L.R and H.L.R containers | Silicone rubber + bismuth | Liquid Spray |
| | oxide, | |
| | boron carbide & | |
| | barium sulfate | |
| Decommissioning of N.P.S | Silicone rubber + bismuth | Liquid Spray |
| | oxide, | |
| | boron carbide & | |
| | barium sulfate | |
| Decommissioning of submarines | Silicone rubber + bismuth | Liquid Spray |
| | oxide, | |
| | boron carbide & | |
| | barium sulfate | |
| Submarine reactors shielding | Bismuth metal + polyester | Injected Liquid |
| | epoxy | |
| Transport containers (Type A & B) | Silicone rubber + bismuth | Liquid Spray |
| | oxide, | |
| | boron carbide & | |
| | barium sulfate | |
| Storage of nuclear warheads | Silicone rubber + tungsten | Pre-fabricated in Molds |
| | carbide, | |
| | copper metal, | |
| | barium sulfate, | |
| | boron carbide, | |
| | transmetals & | |
| | silicon oxide | |
| Spent Fuel Ampoule | Silicone rubber + tungsten | Injected Liquid |
| | carbide, | |
| | copper metal, | |
| | barium sulfate, | |
| | boron carbide, | |
| | transmetals & | |
| | silicon oxide | |
| Radiation shielding armament | Silicone rubber + tungsten | Liquid |
| | carbide, | |
| | copper metal, | |
| | barium sulfate, | |
| | boron carbide, | |
| | transmetals & | |
| | silicon oxide | |
| Dust suppressant application | Silicone rubber + bismuth | Experiment Coating |
| | oxide, | |
| | boron carbide & | |
| | barium sulfate | |
| X-ray rooms | Bismuth metal + polyester | Liquid or Plates |
| | epoxy | |
| X-Ray equipment | Bismuth metal + polyester | Pre-fabricated Parts Injection |
| | epoxy | Molding |
| X-Ray room Aprons | Silicone rubber + bismuth | Pre-fabricated Coating |
| | oxide, | |
| | boron carbide & | |
| | barium sulfate | |
| Walls for Linear Accelerator Rooms | Bismuth metal + polyester | Liquid and Plates |
| | epoxy | |
| Cabinets for Isotopes | Copper metal + polyester | Plates |
| | epoxy | |
| Doors X-Ray Linear Accelerator Rms. | Copper metal + polyester | Liquid in Molds |
| | epoxy | |
| Isotope containers (pigs) | Copper metal + polyester | Injection Molding |
| | epoxy | |

The table gives broad indications of how the various components are selected for specific indications. Broadly, the components can be thought of as belonging to three groups: the matrix group, the blocker group and the special material group. As already explained the matrix group consist of appropriate organic matrices such as silicone rubbers (RTV and RTF, as examples), epoxies (polyester epoxies and special high temperature epoxies such as “302” and related resins from Thermoset-Lord Chemical Product, Indianapolis, Iowa and other resins as mentioned above. The matrix makes up between about 7 and 15% by weight of the shielding material.

Radiation blockers make up the major portion of the shielding material and range from about 50 to 93% by weight of the final composition. Radiation blockers include the heavy metals and their compounds detailed above (copper, lead, tin, tungsten, antimony, indium, and bismuth) including chemical compounds and mixtures of the same with copper, bismuth, bismuth oxide and tungsten carbide being especially preferred. The radiation blockers and other additives are preferably in the form of a vary fine powder or are soluble in the organic matrix.

The remaining components (Components 3-7) can be considered as “special materials” which make up about 0% to about 15% by weight of the composition and are selected to fulfill special needs. That is, Component 3 is added when neutrons are significantly present in the radioactive source to be shielded. Boron carbide is an especially preferred form of Component 3 in cases where significant thermal conductivity is advantageous. Depending on the strength of the neutron radiation more or less of the neutron absorbing material is used. Below about 2.5% by weight the neutron absorbing material is not particularly effective. If quantities much above 10% by weight are used, the gamma shielding begins to suffer. Often a combination gamma/neutron shielding material (e.g., barium) is a useful compromise. Component 4 (diamond powder) can be added and metallic blockers (Component 2) can be used. Above about 5% by weight the diamond powder becomes less attractive because of cost and loss of radiation shielding. For thermal strength and resistance Component 5 (silicon dioxide) can be included. Again, the upward range of silicon dioxide is about 5% except in relatively low radiation situations where lesser shielding is acceptable. For additional gamma and neutron-shielding as well as electron conductivity, a secondary shield such as Component 6 (barium sulfate) is added. Again, the optimum level of this component is not more than about 5% by weight of the entire composition. In situations where there is a significant likelihood of hydrogen gas accumulation, Component 7 (metallic and intermetallic hydrogen absorbing compounds) is optionally included. Optimal levels of hydrogen absorbing materials is between about 2% and about 8% by weight. Finally, materials to improve the compounding, the color or the texture of the composition-materials like nylon powder or carbon black—can (or may) advantageously be also included. Such materials generally make up at most a few percent by weight of the final composition.

While the possible ranges of components are fairly broad, the following is a current preferred “recipe” for an effective nuclear shielding composition according to the present invention. This general purpose mixture includes all of the seven components. One of skill in the art will appreciate that many more specialized formulae will not necessarily include all of the components. Here the major component by weight is Component 2 (tungsten carbide powder of 99.99% purity) which makes up 55% by weight of the final composition. Component 3 is a mixture of boron carbide and boron nitride wherein the carbide makes up 4% and the nitride 1% by weight of the final composition. Component 4 is industrial diamond powder which makes up 0.5% by weight of the composition. Component 5 is quartz powder, which makes up 4.5% by weight of the final composition. Component 6 is barium sulfate which makes up 3% by weight of the final composition and component 7 is a gas absorber-suppressant which makes up 7% by weight of the final composition (this consists of an equal weight mixture of lanthanum/nickel and samarium/cobalt compounds to yield 4% by weight and further of readily “hydrogenated” titanium to yield 3% by weight).

These materials are thoroughly blended in an industrial mixer until the mixture is completely uniform. Then this mixture is thoroughly blended into RTF material Part A (an amount equivalent to 20% by weight of the final mixture). Finally, 5% by weight of the final composition of RTF Part B is blended in and the material is injected into a mold (or a cavity in a waste container) and allowed to polymerize. Polymerization occurs rapidly at essentially room temperature with no requirement for external heating.

Table 2 contains a number of formulae that fall within the present invention. These materials have undergone various types of testing and measurement as will be detailed below.

TABLE 2

| | | | | Primary | | | | Additional | Approx. |
|---|---|---|---|---|---|---|---|---|---|
| | | Matrix | Primary | Shield | Secondary | Secondary | Additional | Component | Density |
| Formula | Matrix | Wt. % l | Shield | Wt. % | Shield | Shield Wt. % | Component | Wt. % | (g/cc) |
| | Polyester | 15% | Bi₂O₃ | 60% | BaSO₄ | 15% | SiO₂ | 9% | |
| | Epoxy | | Powder | | Powder | | Carbon | 1% | 3.2 |
| | Polyester | 8.4% | Bi₂O₃ | 78.1% | BaSO₄ | 13.5% | | | 4.5 |
| | Epoxy | | Powder | | Powder | | | | |
| | Polyester | 8% | Bismuth | 92% | | | | | 6.2 |
| | Epoxy | | Powder | | | | | | |
| | HT | 10% | Tungsten | 75% | Boron | 5% | Al₂O₃ | 10% | 6.2 |
| | Epoxy | | Carbide | | Carbide | | | | |
| | Polyester | 7% | Cu | 93% | | | | | 5.8 |
| | Epoxy | | Powder | | | | | | |
| | HT | 10% | Tungsten | 70% | Boron | 5% | BaSO₄ | 15% | 5.8 |
| | Epoxy | | Carbide | | Carbide | | Powder | | |
| TRS | RTV 116 | 10% | Tungsten | 60% | Boron | 5% | Cu powder | 5% | |
| | | | Carbide | | Carbide | | BaSO₄ pwd. | 10% | |
| | | | | | | | Intermetallic | 6% | |
| | | | | | | | SiO₂ | 4% | |
| MeHr | RTV 116 | 15% | Bismuth | 70% | Boron | 5% | BaSO₄ | 10% | |
| | | | Oxide | | Carbide | | powder | | |
| MeLr | Thermoset | 15 | Cu | 80 | Boron | 5% | | | |
| | 302 | | powder | | Carbide | | | | |
| General | Polyester | 10% | Bismuth | 40% | Boron | 5% | Cu pwd. | 40% | |
| App. | Epoxy | | Oxide | | Carbide | | BaSO₄ | 5% | |
| Mixed | RTF 762 | 15% | Bismuth | 50% | | | Al₂O₃ | 20% | |
| Hi/Low | | | Powder | | | | BaSO₄ | 15% | |

In formula D the silicon dioxide is used for high temperature resistance while the carbon is added as a coloring material. In formula H the alumina is used as a high temperature refractory/ceramic component. In formula G-I the barium sulfate is both a shielding material and an electrical conducting agent. In formula TRS the barium sulfate functions as in G-I while the copper powder acts as a thermal and electrical conductivity enhancer as well as a shielding material. The intermetallic materials serve to absorb hydrogen gas while the silicon dioxide provides high temperature resistance. In formula MeHr the barium sulfate is again a shield and a conductivity component. In formula General App. the coper and barium sulfate function as in formula TRS. In formula Mixed the alumina is a ceramic refractory and barium sulfate is a shield and conductivity component.

Gamma ray and fast neutron shielding characteristics were determined for several of the above formulations. Gamma-ray tests included ⁶⁰Co (average energy 1.25 MeV) and ²⁴¹Am (60 keV). High-energy gamma rays emitted by ⁶⁰Co are typically used as a reference for shielding calculations in the nuclear power industry. Low energy gamma rays given off by ²⁴¹Am are used to give an estimate of the equivalent atomic number (Z) of the material since the mass attenuation coefficient at this energy is highly dependent upon Z. Simple, narrow beam geometry was approximated and the penetrating radiation was detected with a standard NaI detector and scaler. Results are given in Table 3.

Fast neutron removal cross-section (Σᵣ) measurements utilized a PuBe neutron source with an average energy of approximately 4 MeV and a Bonner Sphere neutron spectrometer system. To determine the removal cross section the number of neutrons in the energy range above 1 eV was integrated from the Bonner Sphere results. Shielding samples had a cross sectional area of 30 cm×30 cm. This area can cause some error in this measurement since the neutron mean free path length is approaching this dimension and there may be boundary cause edge effects. Selected measured removal cross sections are also given in Table 3.

The half value layers (HVLs) for ⁶⁰Co decreases as density increases. For example, the half value layer for material G is significantly lower than other formulations due to its much higher density. At the 60 keV energy of ²⁴¹Am, HVLs are also given. These were converted to mass attenuation coefficient and compared with single element materials to estimate an equivalent Z for each material. Materials E, G and G-Flex are approaching the equivalent Z of iron (Z=27), a commonly used shielding material. A secondary test was conducted for measuring ten value “TVL” in narrow and broad beam for material E (at 6 MEV and 18 MEV) and material G (at 6 MEVand 18 MEV). See table 4.

Direct tension and Rockwell hardness tests were conducted to establish tensile strength, elastic modulus, failure strain and hardness characteristics of formula D. It was observed that the average maximum tensile strength is 14.3 MPa. The average elastic modulus from the foil gage was 10.8 GPa. The maximum strength ranges from a high value of 14.8 MPa to a low value of 13.6 MPa. The elastic modulus was fairly consistent for the tests with foil strain gages but varied almost 40% for the tests with just the extensometer. The average elastic modulus measured using the extensometer was computed as 4.62 GPa. This lower value reflects material heterogeneity within the 0.5-inch gage length and resulting averaging effect. Due to the nature of the material, a clip-on extensometer may not provide the same resolution as the bonded foil strain gages. The average elastic modulus found using the bonded gages is more representative of true material behavior. A Brookes Rockwell hardness-testing machine was used for the hardness tests. For plastics and polymers ASTM recommends using the Rockwell L scale, however M and scales were recorded as well. For the L scale, a one-quarter inch diameter ball indenter and a 60-kilogram major load were used. For the M scale, a one-quarter inch diameter ball indenter and a 100-kilogram major load were used. For the S scale, a one-half inch diameter ball indenter and a 100-kilogram major load were used. Average Rockwell hardness values for three samples were L72, M39 and S86.

TABLE 3

| | | ⁶⁰Co | ²⁴¹Am | | PuBe |
|---|---|---|---|---|---|
| | | 1.25 MeV | 0.060 MeV | | High Energy |
| | Density | Gamma | Gamma | | Neutron |
| Material | (g/cm³) | HVL (cm) | HVL (cm) | ˜Z | HVL (cm) |
| D | 3.2 | 6.1 | .22 | 24 | 9.2 |
| E | 4.5 | 3.8 | .16 | 24 | 14 |
| G | 6.2 | 1.8 | .12 | 27 | 20 |
| G-1 | 5.8 | 2.0 | .13 | 36 | 26 |

TABLE 4
Formula E

| | TVL (Narrow Beam) | TVL (Broad Beam) |
|---|---|---|
| 6 MV | 9.0 cm | 13 cm |
| 18 MV | 11.0 cm | 15 cm |

Formula G

| | TVL (Narrow Beams) | TVL (Broad B) |
|---|---|---|
| 6 MV | 7.5 cm | 11 cm |
| 18 MV | 8.8 cm | 12 cm |

The last four formulae are in Table 2 preferred for the functions alluded to by their names. Formula TRS is especially suited to shielding transport of high radiation items such as spent fuel rods. Formula MeHr is a flexible shielding formula well suited to medical x-ray aprons. Formula MeLr is designed for application to linear walls for medical x-ray shielding. Formula General App. is designed for general purpose shielding applications while formula Mixed Hi/Low is intended for shielding of mixed tranuranics containing both high and low radiation components.

The inventive material is flexible and quite resistant to high temperatures and high radiation fluxes. If held at a high temperature materials formulated with ceramic metal oxides, as will be understood by one of skill in the art, will transform into strong ceramics. The compositions are useful as a shielding component in any high radiation application. Especially suitable are nuclear power plants, nuclear fuel processing and reprocessing facilities and facilities for storage of spent nuclear fuels. For example, a good application of the present invention is as a shielding material in containers designed for transport and/or storage of spent nuclear fuels. One such container can be produced by making an container sized to hold a spent fuel rod assembly. The container is best fabricated from a strong and thermally/chemically resistant metal such as stainless steel. The container is fabricated with a double wall construction wherein a space exists between the inner wall and the outer wall. This space is filled by the composition of the present invention—a particularly useful form here can be a foam formulation. That is, after the components are completely mixed with RTF silicone rubber Part A, the RTF silicone rubber Part B is rapidly mixed in and the resulting mixture is injected into the space of the container. The mixture foams to completely fill the space and polymerizes to provide a resistant shielding material. A double-walled lid for the container is constructed along the same lines. The shielding material greatly attenuates the escaping radiation making transport and storage much safer.

The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

1. A composition for stopping high fluxes of gamma and neutron radiation and showing resistance to high temperatures, said composition comprising a uniform mixture of:
between about 7% and about 15% by weight an organic polymer selected from the group consisting of silicone rubber, siloxanes, silanols, epoxies, vinyl elastomers and fluorocarbon polymers for providing a flexible or resilient matrix;
between about 50% to about 93% by weight of a primary gamma radiation shielding material selected from the group consisting of copper, lead, tin, tungsten, antimony, indium, and bismuth for increasing gamma radiation shielding of the mixture; and
sufficient additional materials to constitute 100%.

2. The composition according to claim 1, wherein the primary gamma shielding material is metallic.

3. The composition according to claim 1, wherein the gamma shielding material comprises tungsten.

4. The composition according to claim 3, wherein the tungsten comprises tungsten carbide.

5. The composition according to claim 1, wherein the primary gamma shielding material is a salt.

6. The composition according to claim 5, wherein the salt comprises a salt of iodine.

7. The composition according to claim 1, wherein the additional materials are selected from the group consisting of a neutron absorbing material, diamond powder, silicon dioxide, barium sulfate, and a hydrogen absorbing material.

8. The composition according to claim 7, wherein the neutron absorbing material comprises between about 2.5% and about 10% by weight of the mixture.

9. The composition according to claim 7, wherein the neutron absorbing material is selected from the group consisting of boron, cadmium and gadolinium.

10. The composition according to claim 7, wherein the neutron absorbing material comprises boron.

11. The composition according to claim 10, wherein the boron comprises one of boron carbide, boron nitride and a mixture of boron carbide and boron nitride.

12. The composition according to claim 7, wherein the diamond powder comprises up to about 5% by weight of the mixture to increase thermal conductivity.

13. The composition according to claim 7, wherein the silicon dioxide comprises up to about 5% by weight of the mixture.

14. The composition according to claim 7, wherein the powdered silicon dioxide comprises quartz.

15. The composition according to claim 7, wherein the barium sulfate comprises up to about 5% by weight of the mixture.

16. The composition according to claim 7, wherein the hydrogen absorbing material comprises between about 2% and 10% of the mixture.

17. The composition according to claim 7, wherein the hydrogen absorbing material is selected from the group consisting of palladium, lithium, calcium, titanium, scandium, lithium nickel compounds, lanthanum nickel compounds, yttrium nickel compounds, samarium cobalt compounds and yttrium cobalt compounds.

18. The composition according to claim 7, wherein the hydrogen absorbing material comprises sponge palladium.

19. The composition according to claim 1, wherein the organic polymer comprises a silicone rubber.

20. The composition according to claim 19, wherein the silicone rubber is formulated to produce a flexible foam upon polymerization.

21. The composition according claim 7, wherein the organic polymer consists essentially of silicone rubber foam, the gamma radiation shielding material consists essentially of tungsten carbide, and the neutron absorbing material consists essentially of boron.

22. A container for highly radioactive material comprising:
an inner container;
an outer container surrounding the inner container and spaced apart therefrom; and
a space between the inner container and the outer container, said space filled with the composition of claim 1.

23. A composition for stopping high fluxes of gamma and neutron radiation and showing resistance to high temperatures, said composition comprising a uniform mixture of:
between about 5% and about 15% by weight silicone rubber for providing a flexible matrix;
between about 50% and about 75% by weight of powdered tungsten for increasing gamma radiation shielding of the mixture;
between about 2.5% and about 10% by weight of powdered boron carbide for increasing neutron absorption of the mixture;
up to about 15% by weight of barium sulfate powder for increasing neutron absorption and electrical conductivity of the mixture; and
between about 2% and 8% by weight of a material selected from the group consisting of palladium, lithium, calcium, titanium, scandium, lithium nickel compounds, lanthanum nickel compounds, yttrium nickel compounds, samarium cobalt compounds and yttrium cobalt compounds for absorbing hydrogen gas.

24. A container for highly radioactive material comprising:
an inner container;
an outer container surrounding the inner container and spaced apart therefrom; and
a space between the inner container and the outer container, said space filled with the composition of claim 23.

25. A composition for stopping high fluxes of gamma and neutron radiation and showing resistance to high temperatures, said composition comprising a uniform mixture of:
between about 5% and about 15% by weight silicone rubber for providing a flexible matrix;
between about 60% and about 75% by weight of bismuth oxide for increasing gamma radiation shielding of the mixture;
between about 2.5% and about 10% by weight of powdered boron carbide for increasing neutron absorption of the mixture; and
up to about 15% by weight of barium sulfate powder for increasing neutron absorption and electrical conductivity of the mixture.

26. A composition for stopping high fluxes of gamma and neutron radiation and showing resistance to high temperatures, said composition comprising a uniform mixture of:
between about 5% and about 15% by weight high temperature epoxy for providing a resilient matrix;
between about 65% and about 85% by weight of copper metal for increasing gamma radiation shielding of the mixture; and
between about 2.5% and about 10% by weight of powdered boron carbide for increasing neutron absorption of the mixture.

27. A composition for stopping high fluxes of gamma and neutron radiation and showing resistance to high temperatures, said composition comprising a uniform mixture of:
between about 5% and about 15% by weight polyester epoxy for providing a resilient matrix;
between about 35% and about 55% by weight of bismuth oxide for increasing gamma radiation shielding of the mixture;
between about 35% and about 55% by weight of copper metal for increasing gamma radiation shielding and conductivity of the mixture;
between about 2.5% and about 10% by weight of powdered boron carbide for increasing neutron absorption of the mixture; and
between about 2.5% and about 10% by weight of barium sulfate powder for increasing neutron absorption and electrical conductivity of the mixture.

28. A composition for stopping fluxes of gamma and neutron radiation and showing resistance to high temperatures, said composition comprising a uniform mixture of:
between about 10% and about 20% by weight polyester silicone rubber foam as a matrix;
between about 35% and about 55% by weight of bismuth metal for increasing gamma radiation shielding of the mixture;
between about 15% and about 25% by weight of alumina as a refractory ceramic precursor; and
between about 10% and about 20% by weight of barium sulfate powder for increasing neutron absorption and electrical conductivity of the mixture.
